(19) United States
(12) Patent Application Publication
(10) Pub. No.: US 2013/0221848 A1
(43) Pub. Date: Aug. 29, 2013

(54) SYSTEM, METHOD AND COMPUTER PROGRAM PRODUCT FOR REDUCING A THERMAL LOAD ON AN ULTRAVIOLET FLASH LAMP

(71) Applicant: LOCKHEED MARTIN CORPORATION, (US)

(72) Inventor: Edward Jozef Miesak, Windermere, FL (US)

(73) Assignee: LOCKHEED MARTIN CORPORATION, Bethesda, MD (US)

(21) Appl. No.: 13/776,245

(22) Filed: Feb. 25, 2013

Related U.S. Application Data
(60) Provisional application No. 61/602,950, filed on Feb. 24, 2012.
(60) Provisional application No. 61/606,886, filed on Mar. 5, 2012.

(51) Int. Cl. H05B 37/02; F21V 29/00

(52) U.S. Cl. CPC H05B 37/02; F21V 29/22
USPC 315/112; 315/246

(57) ABSTRACT

A system including a power supply configured to supply electrical power to a light source, and a circuit configured to activate the light source at a driving pulse to produce a light from the light source at a desired output spectral range so that a thermal load on the light source is reduced is disclosed. A method and a non-transitory processor readable storage medium, providing an executable computer program product, the executable computer program product comprising a computer software code that, when executed on a processor are also disclosed.

### CROSS-REFERENCE TO RELATED APPLICATIONS

This application claims the benefit of U.S. Provisional Application No. 61/602,950 filed Feb. 24, 2012, and U.S. Provisional Application No. 61/606,886 filed Mar. 5, 2012, and incorporated herein by reference in their entirety.

### BACKGROUND

Embodiments relate to a light system and, more particularly, reducing a thermal load on the light system.

In the photography industry, a flash lamp is typically used to illuminate a target so that the target may be photographed with sufficient illumination to obtain a clear image of the target. A flash lamp is a thermal device that generates light as a result of heat. The light generated is a brief sudden burst of bright light. Such flash lamps are designed to produce an intense broad band output of light covering all visible wavelengths and beyond as they may cover from near infrared (NIR) to ultraviolet-C (UVC).

When used in video mode the flash lamp needs to run at repetition rates at least equal to the frame rate of the video camera, about 30 Hz or more. Sustained operation at these repetition rates causes the flash lamp to heat up. The heat generated effects the lamp negatively and results in a shortened lifespan for the flash lamp.

Furthermore, because certain illumination requirements involve a. desire to have light at a certain spectrum, such as but not limited to an ultraviolet spectrum, to be emitted from the flash lamp, the flash lamp needs to be operated. at a higher thermal intensity. Doing so will further increase an amount of heat generated by the flash lamp.

One such application where the ultraviolet spectrum may be used is with respect to forensic evidence collection. Currently, when seeking to identify latent forensics evidence, such as, but not limited to, material comprising a fingerprint, standard forensic techniques include using dusting, super-glue fuming, and/or other non-optical techniques. Using any of these forensic techniques however, disrupts or destroys the latent material; hence the fingerprint is lost from being available for further examination at a later time. In a similar manner, when suspicious fluids (including bodily fluids), which may also be classified as latent material, are found, collection methods usually result in destruction of the fluid.

Manufacturers, owners, and users of flash lamps where light in a particular spectrum, such as but not limited to the ultra violet spectrum, would benefit from a system and method which would provide for the flash lamp to operate within the desired spectrum where a thermal load on the heat lamp is reduced during a single pulse duration of illumination and during repetitive durations of illumination.

### SUMMARY

Embodiment relate to a system, method and computer program product for reducing a thermal load on flash lamp to produce a light in a particular spectrum. The system comprises a power supply configured to supply electrical power to a light source, and a circuit configured to activate the light source at a driving pulse to produce a light from the light source at a desired output spectral range so that a thermal load on the light source is reduced.

The method comprises identifying a desired output spectral range of a light to be produced from an illumination source. The method further comprises determining a. driving pulse for the illumination source to extract the light at the desired output spectral range at a duration so that a thermal load on the illumination source is reduced; the duration of the driving pulse is of a width which reduces output from a non-desired output spectral range of the light. The method also comprises illuminating the illumination source at the determined driving pulse to produce the light at the desired output spectral range while reducing the non-desired output spectral range of the light.

The computer program product in on a non-transitory processor readable storage medium, providing an executable computer program product, the executable computer program product comprising a computer software code that. When executed on a processor, the processor is caused to determine a driving pulse for the illumination source to extract the light at the desired output spectral range at a duration so that a thermal load on the illumination source is reduced, the duration of the driving pulse is of a width which reduces output from a non-desired output spectral range of the light. The processor is also caused to command the illumination source to illuminate at the driving pulse to produce the desired output spectral range.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows a system used to determine temporal patterns of ultraviolet-C (UVC) and visible (VIS) to near infrared (NIR) wavelengths;

FIG. 2 shows a graph illustrating signal output and duration of UVC and VIS to NIR determined from the system shown in FIG. 1;

FIG. 3 shows a graphical representation of energy output of VIS to NIR in a first graph compared to UVC in a second graph;

FIG. 4 shows a block diagram of a system illustrating an embodiment;

FIG. 5 further shows a comparison between two repetitive driving pulses; and

FIG. 6 discloses a flowchart illustrating a method for illustrating an embodiment,

### DETAILED DESCRIPTION

Embodiments are described herein with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to non-limiting example applications for illustration. Broadly speaking, a technical effect may be to reduce a thermal load on light source which is used to produce a light in a particular spectrum.

It should be understood that numerous specific details, relationships, and methods are set forth to provide a fill understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

FIG. 1 shows a system to determine temporal patterns of ultraviolet-C (UVC) and visible (VIS) to near infrared (NIR) wavelengths, Plasma flash lamps produce intense a broad band output. Usable energy in the UVC portion of the optical spectrum (160 nm (nanometer)-280 nm, depends on the flash lamp gas, xenon, in this case) is available. In an optical filtering configuration as illustrated, the output of a broad-spectrum (160 nm to >1000 nm) flash lamp 10 can be divided into two wavelength bands, UVC and VIS to NIR (VIS-NIR). In order to separate UVC and VIS-NIR spectral outputs, a filtering arrangement may he used. The flash lamp output is reflected off three neutral density (ND) filters, 12, 13, 14. Each filter 12, 13, 14 has a maximum reflectance coating from about 185 nm to about 200 nm. In the arrangement used, wavelengths less than 206 nm, which is in the UVC range, are reflected with almost ninety-seven percent (97%) efficiency. Wavelengths greater than 206 nm to 390 nm pass through the reflectance coating and are almost completely absorbed in the glass substrate of the filters. Wavelengths greater than 390 nm (VIS to NIR) pass through the reflectance coating and are partially absorbed in the substrate of the filters. Enough VIS to NIR light passes through the first filter, 12, to produce a strong signal on a first detector 16. A second detector 18 reads the UVC light coming from the flash lamp 10. Both detectors 16, 18 are identical with nanosecond (ns) reaction times and a response range from 200 nanometers (nm) to 1100 nm.

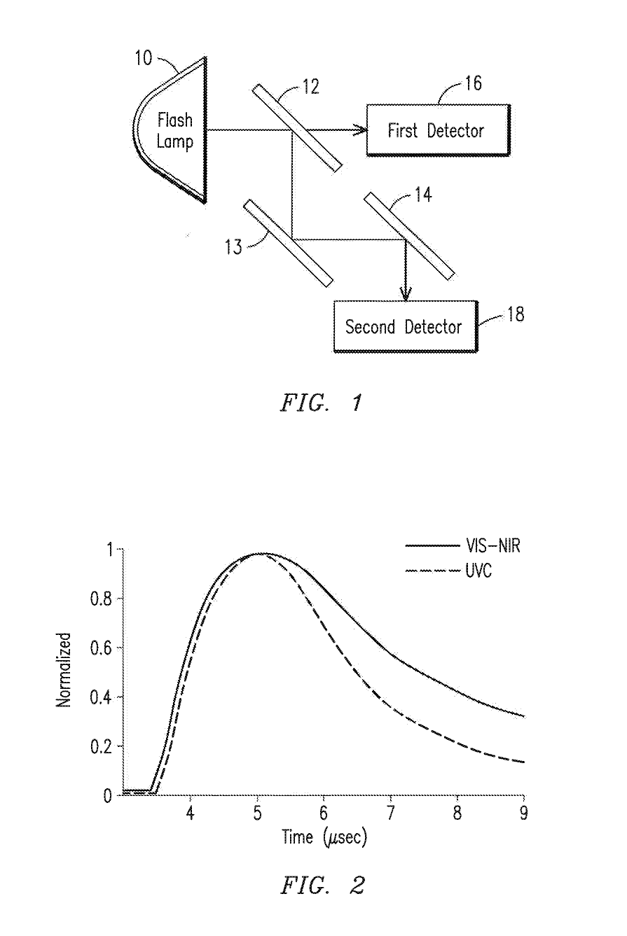

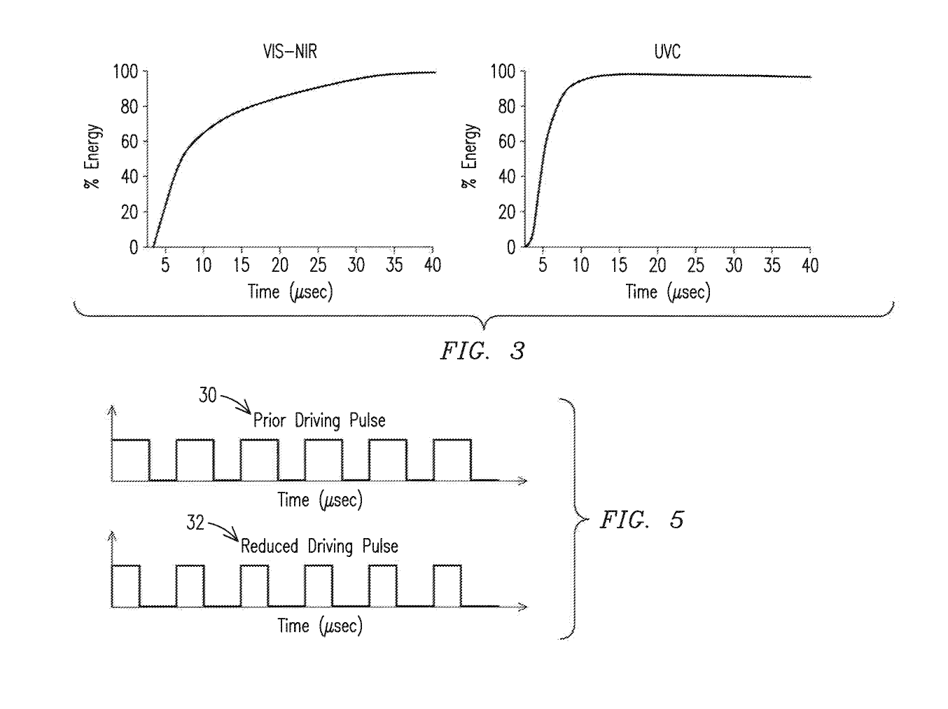

FIG. 2 shows a graph illustrating signal output and duration of UVC and VIS to NW determined from the system shown in FIG. 1. The signal output for UVC is shown as a dashed line and the signal output for VIS to NIR is shown as a solid line. Both signals were normalized to be between zero and 1. The area under each signal was integrated from zero to a max value going from zero to forty (40) micro seconds (μsec) which is the maximum extent of the flash lamp emission, Though FIG. 2 only shows the signals from zero to nine μsec. The graphical representation mimics an electric circuit that drives the flash lamp with a width varying from zero to 40 μsec. However, as further illustrated in FIG. 3, the energy of the UVC wavelength is maximized at about 15 μsec. The output of these integrations represents the optical energy and thermal load of the flash lamp at each pulse width.

FIG. 3 shows a graphical representation of energy output of VIS to NIR compared to UVC. The percentage of energy output of the VIS-NIR is the graph to the left and the percentage of energy output for UVC is the graph on the right. The total energy output (when one hundred percent (100%) is reached) of the UVC wavelength is delivered in the first 15 μsec of the lamp drive signal, which is well before the total energy output of the VIS to NIR wavelength is reached, This result is realized because the UVC pulse generated when the flash lamp illuminates is shorter than that of the VIS-NIR pulse. Based on this information, the inventor concluded that this allows the driving signal of the flash lamp to be shorter than 40 μsec and still obtain the full energy from the UVC wavelength.

Applying on the above percentage of energy output profiles and considering the first graph in FIG. 3, driving the flash lamp with approximately a 9 μsec wide pulse would deliver a thermal load of approximately sixty percent (60%) of the maximum thermal load, namely the VIS to NIR. Thus a reduction in the thermal load of about forty percent (40%) is realized. This 9 μsec wide pulse would deliver approximately ninety-five percent (95%) of the total optical energy available in the UVC wavelength.

Based on the above information developed by the inventor, FIG. 4 shows a block diagram of a system for reducing a thermal load of a flash lamp designed to maximize an output spectral range, such as but not limited to UVC. The flash lamp or light source 10 is disclosed. A power source or power supply 20 is also disclosed. The power source 20 may or may not be an integral part of the flash lamp 10. A circuit 22 is provided. A controller 24 may also be provided, either integral with or separate from the circuit 22.

The circuit 22 may be used to drive the flash lamp 10. More specifically, the circuit 22 may be used to provide electrical power from the power source 20 to the flash lamp 10. This may occur either with communications between the power source 20 and the circuit 22 and/or by the circuit 22 providing a command to the flash lamp 10 (with a controller or processor as part of the flash lamp (not shown)) which in turn sends a signal to the power source 20. The flash lamp 10 may be driven by the circuit 22 only long enough to allow most of the UVC energy out of the lamp 10, then the power is turned off, or the pulse is commanded to cease. In another embodiment, the pulse width is established at a shorter duration than may be identified on the graph in FIG. 3 since even once power is no longer supplied from the power source 20, a delay is realized before the flash lamp 10 ceases to illuminate once no longer powered.

Typically, a length of the pulse, a driving pulse 30, used to operate the flash lamp 10 is typically proportional to the thermal load on the flash lamp 10. This pulse length allows all spectrums of light to be released during illumination, and at a greater thermal load. However, as illustrated in FIG. 5, a shorter pulse 32 may be used to produce a smaller thermal load whereas a greater energy output of the UVC wavelength is realized when compared to the VIS to NIR wavelength. Thus, the circuit 22 activates the flash lamp 10, or light source, at the reduced driving pulse length 32 to produce a light, at a desired spectral range, such as but not limited to UVC, but with a thermal load on the light source 10 being reduced when attempting to obtain the desired wavelength at its normal driving pulse length.. The reduction is realized when the thermal load is compared to a thermal load realized during a normal pulse length or regular operation or use of the light source 10.

FIG. 5 further shows a comparison between two repetitive driving pulses 30, 32. The first driving pulse 30 is a sequence not utilizing embodiment disclosed herein whereas the second driving pulse 32 is based on the embodiments disclosed herein. The flash lamp 10 may be used with an imaging system 34, illustrated in FIG. 4, which may operate in a video mode or may take images in rapid succession. The circuit 22 may repeat a determined driving pulse at a rate at least equal to a frame rate of the imaging system 34. Communication between the circuit 22 and imaging system 34 may be provided to ensure the desired rate is used. Thus, it may be possible to use the flash lamp 10 repetitively where the thermal load is reduced. Hence the life span of the components of the flash lamp 10 is extended.

As further illustrated in FIG. 5, the reduced driving pulse 32 is extracted to be closest to a start of illumination of the flash lamp 10. Additionally, when comparing the system 100 in FIG. 4 to the graphs illustrated in FIG. 3, and the driving pulses in FIG. 5, the reduced driving pulse duration results in the emitted light in a non-desired output spectral range (such as but not limited to other than UVC) being reduced when the light in the desired output spectral range (such as but not limited to UVC) remaining constant.

Turning back to FIG. 4, a heat sink 36 is also disclosed. The use of the heat sink 36 may allow for longer operating times for the lamp 10. Utilizing of the embodiments disclosed however may also allow for smaller flash lamp devices to be used where a size of existing heat sinks may be eliminated or significantly reduced.

The controller 24 may comprise a processor 38. The controller 24 may be used to control the circuit 22. More specifically, the controller 24 may be used to manipulate or control switching the power source 20 on or off, based on inputs from the circuit 22.

In another embodiment, the controller 24 may be manually controlled, thus having an input device 40. The aspects which may be manually provided may include a duration of the pulse width and/or an amount of electrical power provided. When manually controlled, the processor 38/controller 24 may then control the circuit 22 responsive to the manual entry. As a non-limiting example, if a user enters a desired pulse duration, the processor 28 may use the desired pulse duration to determine an amount of power to apply from the power source 20 to the flash lamp 10 based on the specific wavelength of light desired. Thus, in another non-limiting the user may also identify the desired wavelength of light. Other non-limiting examples are possible as will be realized by those skilled in the art after reviewing the embodiments. In each, the intent is that the processor 38 and/or controller 24 may be able to control the circuit 22 to provide a light output from the flash lamp 10 optimized for the input provided by the user, where optimization may include but is not limited to desired wavelength, pulse duration, amount of electrical power provided to the flash lamp, etc. Hence, the controller 24 may provide for manual input of at least one variable to determine the driving pulse, power supplied to the light source, or a desired output spectral range.

Although discussed with respect to the UVC portion of the flash lamp output, the embodiments disclosed are applicable fur a broad range of flash lamp outputs and settings. Stated in more general terms, the embodiments relate to shortening a driving pulse for a flash lamp or similar pulsed illumination source in order to extract an output spectral range of interest that occurs closer to the start of illumination/operation. By shortening the driving pulse in this way, a thermal load is reduced because the operating cycle of the device is shorter.

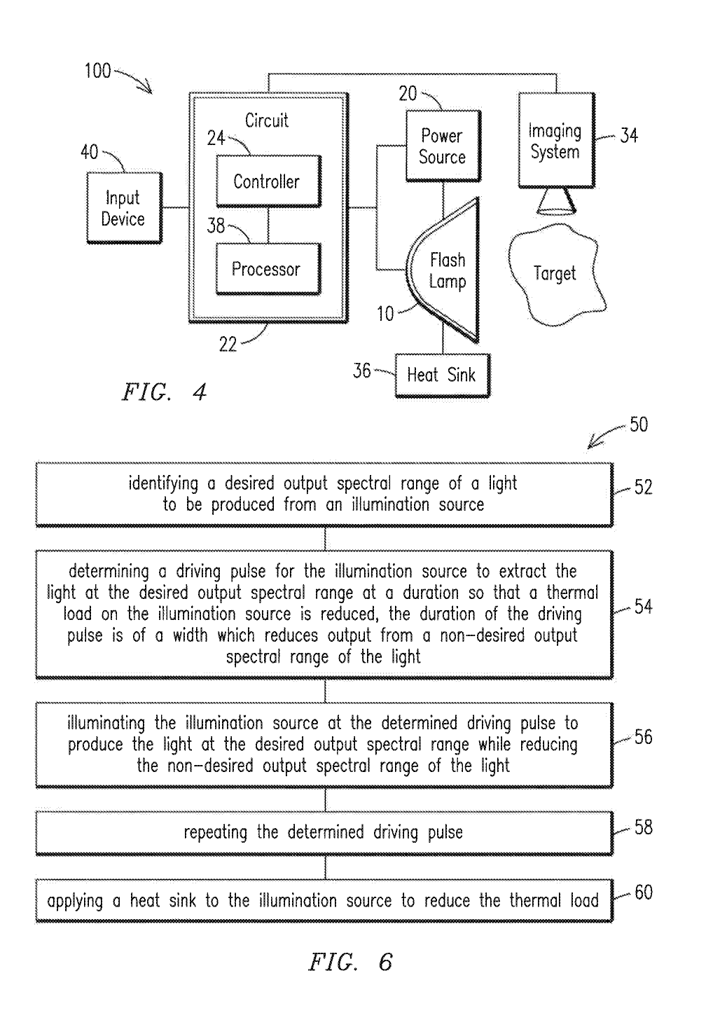

FIG. 6 discloses a flowchart illustrating a method for illustrating an embodiment. The method 50 comprises identifying a desired output spectral range of a light to be produced from an illumination source, at 52. The method also comprises determining a driving pulse for the illumination source to extract the light at the desired output spectral range at a duration so that a thermal load on the illumination source is reduced; the duration of the driving pulse is of a width which reduces output from a non-desired output spectral range of the light, at 54. The method also comprises illuminating the illumination source at the determined driving pulse to produce the light at the desired output spectral range while reducing the non-desired output spectral range of the light, at 56.

The method may further comprise repeating the determined driving pulse, at 58. As a non-limiting example, the driving pulse may be repeated for use when the imaging system 34 is taking video (or motion) images. The rate may at least equal to a frame rate of an imaging system, but the rate may be any rate desired by a user. Additionally, the system and method may be operated at different frequencies. The method may also further comprise applying a heat sink to the illumination source to reduce the thermal load, at 60. The driving pulse may be determined based on the desired output spectral range being in an ultraviolet spectral range. Determining the driving pulse may further comprise determining the driving pulse to extract the desired output spectral range closest to a start of illumination of the illumination source. The determined drive pulse may be a shorter duration than a second drive pulse used to produce the non-desired output spectral range.

Persons skilled in the art will recognize that an apparatus, such as a data processing system, including a CPU, memory, I/O, program storage, a connecting bus, and other appropriate components, could be programmed or otherwise designed to facilitate the practice of embodiments of the method. Such a system would include appropriate program means for executing the method. Also, an article of manufacture, such as a pre-recorded disk, computer readable media, or other similar computer program product, for use with a data processing system, could include a storage medium and program means recorded thereon for directing the data processing system to facilitate the practice of the method.

Embodiments may also be described in the general context of computer-executable instructions, such as program modules, being executed by any device such as, but not limited to, a computer, designed to accept data, perform prescribed mathematical and/or logical operations usually at high speed, where results of such operations may or may not be displayed. Generally, program modules include routines, programs, objects, components, data structures, etc., that perform particular tasks or implement particular abstract data types. In an embodiment, the software programs that underlie embodiments can be coded in different programming languages, for use with different devices, or platforms. It will be appreciated, however, that the principles that underlie the embodiments can be implemented with other types of computer software technologies as well.

Moreover, those skilled in the art will appreciate that the embodiments may be practiced with other computer system configurations, multiprocessor systems, microprocessor-based or programmable consumer electronics, minicomputers, mainframe computers, and the like. Embodiments may also be practiced in distributed computing environments where tasks are performed by processing devices located at different locations on board of a vehicle or stationary device, that are linked through at least one communications network in a distributed computing environment, program modules may be located in both local and remote computer storage media including memory storage devices.

In view of the above, a non-transitory processor readable storage medium is provided. The storage medium comprises an executable computer program product which further comprises a computer software code that, when executed on a processor, causes the processor to determine a driving pulse for the illumination source to extract the light at the desired output spectral range at a duration so that a thermal load on the illumination source is reduced, the duration of the driving pulse is of a width which reduces output from a non-desired output spectral range of the light, and to command the illumination source to illuminate at the driving pulse to produce the desired output spectral range.

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

The terminology used herein is for the purpose of describing particular embodiments only and is not intended to be limiting to this Disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this Disclosure belongs. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Furthermore, while embodiments have been described with reference to various embodiments, it will be understood by those having ordinary skill in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered. Moreover, unless specifically stated, any use of the terms first, second, etc., does not denote any order or importance, but rather the terms first, second, etc., are used to distinguish one element from another.

What I claim is:

1. A system comprising:
a power supply configured to supply electrical power to a light source; and
a circuit configured. to activate the light source at a driving pulse to produce a light from the light source at a desired output spectral range so that a thermal load on the light source is reduced.

2. The system according to claim 1, further comprising a controller configured to control the circuit.

3. The system according to claim 2, wherein the controller provides for manual input of at least one variable to determine the driving pulse, power supplied to the light source, or a desired output spectral range.

4. The system according to claim 2, wherein the controller comprises at least one processor.

5. The system according to claim 1., wherein the circuit is configured to repeat determined driving pulse at a rate at least equal to a frame rate of an imaging system.

6. The system according to claim 1, wherein the driving pulse is determined based. on the desired output spectral range being in an ultraviolet spectral range.

7. The system according to claim 1, wherein determining the driving pulse further comprises determining the driving pulse to extract the desired output spectral range closest to a start of illumination of the light source.

8. The system according to claim 1, wherein the light at a non-desired output spectral range is reduced as the light at the desired output spectral range is increased.

9. The system according to claim 1, further comprising a heat sink configured to reduce the thermal load.

10. A method comprising:
identifying a desired output spectral range of a light to be produced from an illumination source;
determining a driving pulse for the illumination source to extract the light at the desired output spectral range at a duration so that a thermal load on the illumination source is reduced, the duration of the driving pulse is of a width which reduces output from a non-desired output spectral range of the light; and
illuminating the illumination source at the determined driving pulse to produce the light at the desired output spectral range while reducing the non-desired output spectral range of the light.

11. The method according to claim 10, further comprising repeating the determined driving pulse.

12. The method according to claim 10, wherein the driving pulse is determined based on the desired output spectral range being in an ultraviolet spectral range.

13. The method according to claim 10, wherein determining the driving pulse further comprises determining the driving pulse to extract the desired output spectral range closest to a start of illumination of the illumination source.

14. The method according to claim 10, wherein the determined drive pulse is a shorter duration than a second drive pulse used to produce the non-desired output spectral range.

15. The method according to claim 10, further comprising applying a heat sink to the illumination source to reduce the thermal load.

16. A non-transitory processor readable storage medium, providing an executable computer program product, the executable computer program product comprising a computer software code that, when executed on a processor, causes the processor to:
determine a driving pulse for the illumination source to extract a light at a desired output spectral range at a duration so that a thermal load on the illumination source is reduced, the duration of the driving pulse is of a width which reduces output from a non-desired output spectral range of the light; and
command the illumination source to illuminate at the driving pulse to produce the desired output spectral range.

17. The processor readable storage medium according to claim 16, further causes the processor to repeat the determined driving pulse.

18. The processor readable storage medium according to claim 16, wherein the driving pulse is determined based on the desired output spectral range being in an ultraviolet spectral range.

19. The processor readable storage medium according to claim 16, wherein causing the process to determine the driving pulse further comprises the processor to determine the driving pulse to extract the desired output spectral range closest to a start of illumination of the illumination source.

20. The processor readable storage medium according to claim 16, wherein the determined drive pulse is a shorter duration than a second drive pulse used to produce the non-desired output spectral range.
